(19) United States
(12) Patent Application Publication
(10) Pub. No.: US 2017/0077567 A1
(43) Pub. Date: Mar. 16, 2017

(54) BATTERY DEVICE

(71) Applicant: Hyundai Motor Company, Seoul (KR)

(72) Inventors: Hae Kyu Lim, Bucheon (KR); Yong Hwan Choi, Yongin (KR); Yoon Cheol Jeon, Suwon (KR)

(21) Appl. No.: 14/950,939

(22) Filed: Nov. 24, 2015

(30) Foreign Application Priority Data
Sep. 14, 2015 (KR) 10-2015-0129892

(51) Int. Cl. H01M 10/6555; H01M 10/625; H01M 10/613; H01M 10/48

(52) U.S. Cl. CPC H01M 10/6555; H01M 10/486; H01M 10/625; H01M 10/613; H01M 2220/20

(57) ABSTRACT

A battery device is provided. The battery device includes a battery module having a plurality of battery cells and a plurality of plates disposed between the plurality of battery cells to perform a heat exchange and a battery housing that accommodates the battery module and has opened apertures through which the plurality of plates protrude to the exterior. A heat sink includes a plurality of discharge grooves formed therein to fixedly insert the plurality of plates into the plurality of discharge grooves, seal the battery housing, and discharge heat of the plates. In particular, a sealing structure of the battery module reduces humidity to improve robustness and stability and improve the reliability of a product, and volume energy density. Further the mass energy density is improved by an indirect cooling and a gas discharge venting performed in a unit of the battery module, increasing marketability.

### CROSS-REFERENCE TO RELATED APPLICATION

This application is based on and claims the benefit of priority to Korean Patent Application No. 10-2015-0129892, filed on Sep. 14, 2015 in the Korean Intellectual Property Office, the disclosure of which is incorporated herein in its entirety by reference.

### TECHNICAL FIELD

The present disclosure relates to a battery device, and more particularly, to a battery device that improves reliability related to humidity by securing sealing performance of an indirect cooling battery module unit, and securing venting performance accordingly.

### BACKGROUND

Generally, since reliability and stability of a battery system act as the important factors that determine marketability of an electric vehicle, the electric vehicle should maintain an appropriate temperature range of the battery system, (e.g., about 35° C. to 40° C.) to prevent degradation in performance of a battery by various changes in the exterior temperature. For example, a heat control system for a pouch cell module that maintains the appropriate temperature of the battery in a low temperature environment while having excellent heat dissipation performance in a general climatic condition may be used.

In particular, the battery for the electric vehicle, due to heat generated by high speed charging, high output, the number of repeatedly charging times, and the like, a local temperature difference between battery cells occurs, or a thermal runaway phenomenon hindering efficiency and stability of the battery occurs, known to be caused by lack of capability that emits or diffuses heat to the exterior compared to heat generated from the interior of the battery. Furthermore, according to the related art, as illustrated in FIG. 1, a battery module 1 is sealed with a non-woven pad or side cover portions thereof are fused (A) with laser. However securing an airtight performance is difficult due to a post-assembly of a cover and a wire, and humidity is introduced during reliability test of high temperature and high humidity.

The above information disclosed in this section is merely for enhancement of understanding of the background of the invention and therefore it may contain information that does not form the prior art that is already known in this country to a person of ordinary skill in the art.

### SUMMARY

The present disclosure provides a battery device capable of improving reliability related to humidity by securing sealing performance of an indirect cooling battery module unit, and securing venting performance accordingly.

In one aspect, an exemplary embodiment of the present disclosure, a battery device may include a battery module having a plurality of battery cells and a plurality of plates disposed between the plurality of battery cells to perform a heat exchange, a battery housing that may accommodate the battery module and have opened apertures through which the plurality of plates protrude to the exterior, a heat sink having have a plurality of discharge grooves formed therein to fixedly insert the plurality of plates into the plurality of discharge grooves, seal the battery housing, and discharge heat of the plates.

The battery device may further include a housing cover that seals the battery housing, wherein a bottom surface of the battery housing may be included with an opening through which the battery module may be inserted. The housing cover may be fused with the housing to seal the opening. The battery module may further include heat controlling plates disposed between the battery cells to minimize thermal resistance upon contact with the battery cells. The cell covers may be provided to both ends of the battery module to protect the battery module. The housing cover may include a temperature sensor configured to measure an internal temperature of the battery housing. The battery housing may include terminals that maintain an airtight seal within an inside of the battery housing. The battery housing may be mounted with a venting component through which gas may be discharged.

According to another exemplary embodiment, a battery device may include a battery module having a plurality of plates disposed between a plurality of battery cells and formed of an aluminum material that allows a heat transfer of the battery cells, heat controlling plates disposed between the battery cells to minimize thermal resistance upon contact with the battery cells, and cell covers provided to both ends of the plurality of battery cells to protect the battery cells. Further, a battery housing may form an opening in a bottom surface thereof to insert the battery module into the opening, fuse a housing cover to the opening with laser to seal a lower portion of the battery housing, and form a plurality of apertures in a top surface thereof to allow the plurality of plates protrude to the exterior through the plurality of apertures. Additionally a heat sink may be disposed on the top surface of the battery housing and may have a plurality of discharge grooves formed therein to fixedly insert the plurality of plates into the plurality of discharge grooves, thereby discharging heat of the plates (e.g., at the same time) while sealing an upper portion of the battery housing.

### BRIEF DESCRIPTION OF THE DRAWINGS

The above and other objects, features and advantages of the present disclosure will be more apparent from the following detailed description taken in conjunction with the accompanying drawings:

FIG. 1 is an exemplary diagram illustrating a battery device according to the related art

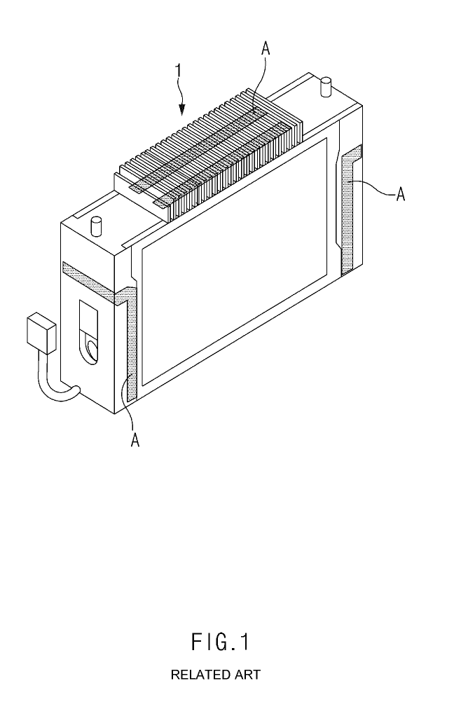

FIG. 2 is an exemplary diagram illustrating a battery module of a battery device according to an exemplary embodiment of the present disclosure;

FIG. 3 is an exemplary diagram illustrating cell covers mounted on the battery module of the battery device according to an exemplary embodiment of the present disclosure;

FIG. 4 is an exemplary exploded perspective view illustrating the battery device according to an exemplary embodiment of the present disclosure;

FIG. 5 is an exemplary diagram illustrating the battery device according to an exemplary embodiment of the present disclosure;

FIG. 6 is an exemplary cross-sectional view illustrating the battery device according to an exemplary embodiment of the present disclosure;

FIG. 7 is an exemplary cross-sectional view illustrating heat transfer and exhaust processes of the battery device according to an exemplary embodiment of the present disclosure.

### DETAILED DESCRIPTION

Exemplary embodiments of the present disclosure will be described in detail with reference to the accompanying drawings. While the invention will be described in conjunction with exemplary embodiments, it will be understood that present description is not intended to limit the invention to those exemplary embodiments. On the contrary, the invention is intended to cover not only the exemplary embodiments, but also various alternatives, modifications, equivalents and other embodiments, which may be included within the spirit and scope of the invention as defined by the appended claims.

It is understood that the tem) “vehicle” or “vehicular” or other similar tem) as used herein is inclusive of motor vehicle in general such as passenger automobiles including sports utility vehicles (SUV), buses, trucks, various commercial vehicles, watercraft including a variety of boats, ships, aircraft, and the like and includes hybrid vehicles, electric vehicles, combustion, plug-in hybrid electric vehicles, hydrogen-powered vehicles and other alternative fuel vehicles (e.g. fuels derived from resources other than petroleum).

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising” when used in this specification, specify the presence of stated features, integers, steps, operations, elements, and/or components, but do not preclude the presence or addition of one or more other features, integers, steps, operations, elements, components, and/or groups thereof. As used herein, the term “and/of” includes any and all combinations of one or more of the associated listed items. For example, in order to make the description of the present invention clear, unrelated parts are not shown and, the thicknesses of layers and regions are exaggerated for clarity. Further, when it is stated that a layer is “on” another layer or substrate, the layer may be directly on another layer or substrate or a third layer may be disposed therebetween.

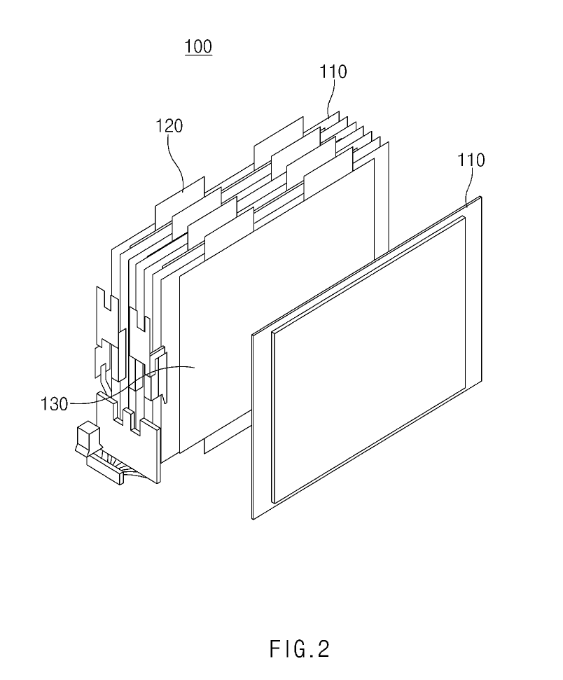

A battery device according to an exemplary embodiment of the present disclosure may include a battery module 100, a battery housing 200, and a heat sink 300, as illustrated in FIGS. 2 to 5. The battery module 100 may include a plurality of battery cells 110 and plates 120. The battery housing 200 may accommodate the battery module 100. The heat sink 300 may seal the batteiy housing 200 and discharge heat generated from the plates 120.

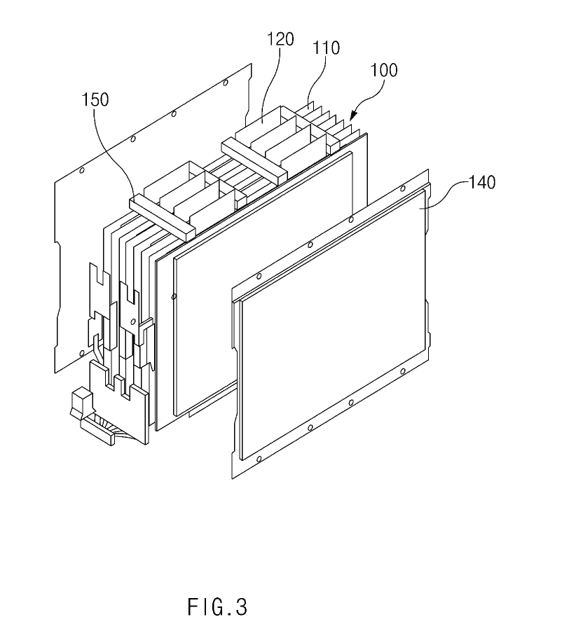

As illustrated in FIGS. 2 and 3, the battery module 100 may include the plurality of battery cells 110 and a plurality of plates 120. The plurality of plates 120 may be disposed between the plurality of battery cells 110 to transfer heat generated from the battery cells 110. For example, the plates 120 may be formed of an aluminum material to improve heat transfer efficiency. In addition, the battery module 100 may further include heat controlling plates 130 and cell covers 140. The heat controlling plates 130 may be disposed between the battery cells 110 to minimize (e.g., reduce) thermal resistance upon contact with the cells. The cell covers 140 may be provided to both ends of the battery module 100 to protect the battery module 100.

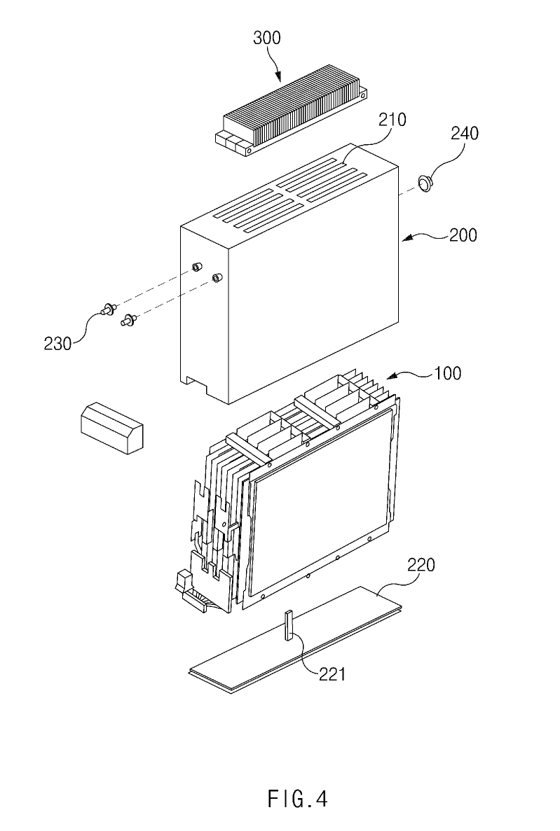

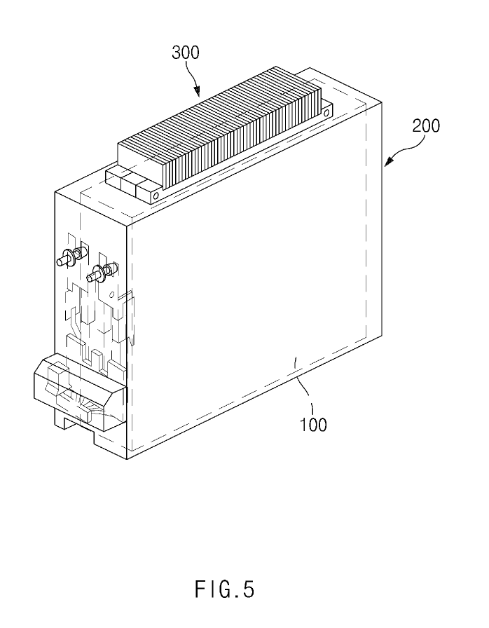

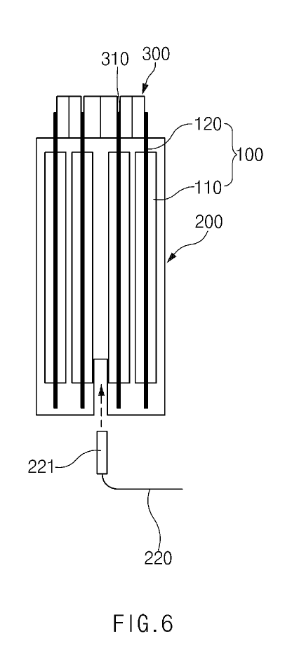

As illustrated in FIGS. 4 and 5, the battery housing 200 may be formed in a case shape having a cavity formed therein (e.g., a space formed within), to accommodate the battery module 100, and may have a top surface in which a plurality of apertures 210 are opened. The plurality of plates 120 may protrude to the exterior through the plurality of apertures 210 formed in the top surface of the battery housing 200. Additionally, the battery housing 200 may include a housing cover 220 that seals the battery housing 200. A bottom surface of the battery housing 200 may include with an opening through which the battery module 100 may be inserted, and the housing cover 220 may be fused with the housing by laser plastics, thereby enabling a seal of the opening. The housing cover 220 may include a temperature sensor 221 configured to measure an internal temperature of the battery housing 200, as illustrated in FIGS. 4 and 6.

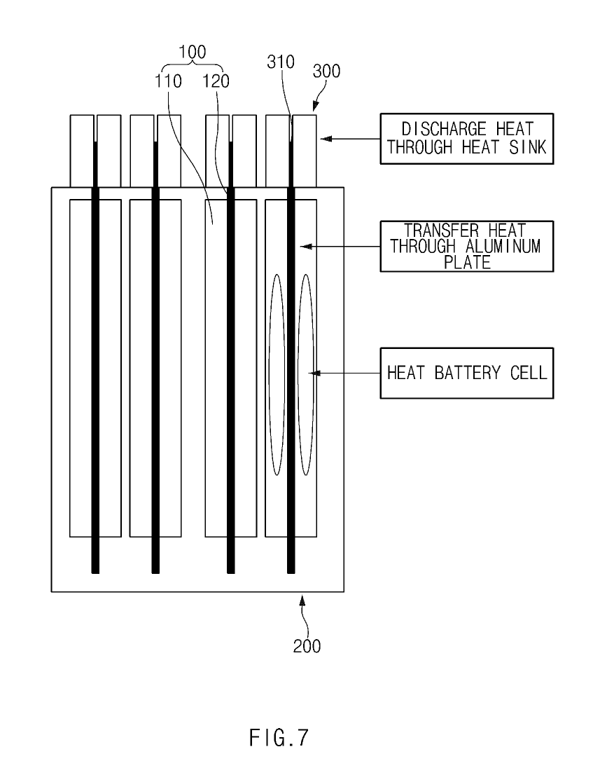

As illustrated in FIGS. 6 and 7, the heat sink 300 may be disposed on the top surface of the battery housing 200 and may have a plurality of discharge grooves 310 formed therein to fixedly insert the plurality of plates 120 into the plurality of discharge grooves 310. Additionally, the heat of the plates 120 may be discharged simultaneously (e.g., at the same time) while sealing the battery housing 200. Further, a front surface of the battery housing 200 may include terminals 230 having a rubber integrated bolt structure that may maintain an airtight seal within the interior of the battery housing 200. For example, a rear surface of the battery housing 200 may be mounted with a venting component 240 through which gas may be discharged.

In other words, according to the present disclosure, as illustrated in FIGS. 2 and 7, the plurality of battery cells 110 and the plates 120 formed of the aluminum material may perform an indirect cooling through a heat exchange and may be laminated, to form the battery module 100. As illustrated in FIG. 3, the cell covers 140 may be connected to both ends of the battery module 100 by support bars 150, and may maintain surface pressure and secure durability against vibration and impact.

As illustrated in FIG. 4, the battery module 100 may be inserted into the battery housing 200 to expose the plates 120 to the top surface of the battery housing 200. A lower portion of the battery housing 200 may be fused with the housing cover 220 to be integrated with each other. As illustrated in FIG. 5, the heat sink 300 may be disposed on the top surface of the battery housing 200 and may be coupled to the plates 120. The top surface of the battery housing 200 may be sealed simultaneously (e.g., at the same time) while heat of the plates 120 discharges. Additionally, the terminals 230 may be formed in one surface (e.g., a first surface) of the battery housing 200 to improve the airtight seal of the within an interior of the battery housing 200, and the venting component 240 may be formed on the other surface of the battery housing 200 may discharge gas in a single direction.

In particular, the battery device according to the present disclosure may include the battery module 100 having include the plurality of plates 120 disposed between the plurality of battery cells 110 and formed of the aluminum material that allows the heat transfer of the battery cells 110 to be performed. For example, the heat controlling plates 130 disposed between the battery cells 110 may minimize thermal resistance upon contact with the battery cells 110. The cell covers 140 may be provided to both ends of the plurality of battery cells 110 to protect the battery cells 110. The battery housing 200 may form the opening in the bottom surface thereof to insert the battery module 100 through the opening. Further the housing cover 220 may be fused to the opening with laser to seal the lower portion of the battery housing 200, and may form the plurality of fixing apertures 210 in the top surface thereof and the plurality of plates 120 may protrude to the exterior through the plurality of apertures 210.

The heat sink 300 may be disposed on the top surface of the battery housing 200 and may have the plurality of discharge grooves 310 formed therein to fixedly insert the plurality of plates 120 into the plurality of discharge grooves 310. For example, the heat of the plates 120 may be discharged simultaneously (e.g., at the same time) while sealing an upper portion of the battery housing 200. Accordingly, a sealing structure of the battery module 100 may reduce an occurrence of humidity to improve robustness and stability. The reliability of a product, and volume energy density and mass energy density may be improved by the indirect cooling. Further, a gas discharge venting may be performed in a unit of the battery module 100, thereby increasing marketability.

As described above, according to the exemplary embodiments of the present disclosure, the sealing structure of the battery module may reduce the occurrence of humidity to improve robustness and stability, thereby increasing the reliability of the product. Further a volume energy density and mass energy density may be improved by the indirect cooling. The gas discharge venting may be performed in the unit of the battery module, to increase marketability.

Hereinabove, although the present disclosure has been described with reference to exemplary embodiments and the accompanying drawings, the present disclosure is not limited thereto, but may be variously modified and altered by those skilled in the art to which the present disclosure pertains without departing from the spirit and scope of the present disclosure claimed in the following claims.

What is claimed is:

1. A battery device, comprising:
a battery module that includes a plurality of battery cells and a plurality of plates disposed between the plurality of battery cells to perform a heat exchange;
a battery housing that accommodates the battery module and has opened apertures through which the plurality of plates protrude to the exterior; and
a heat sink having a plurality of discharge grooves formed therein to fixedly insert the plurality of plates into the plurality of discharge grooves, seal the battery housing, and discharge heat of the plates.

2. The battery device according to claim 1, further comprising:
a housing cover that seals the battery housing,
wherein a bottom surface of the battery housing includes an opening through which the battery module is inserted, and the housing cover is fused with the housing to seal the opening.

3. The battery device according to claim 1, wherein the battery module further includes:
heat controlling plates disposed between the battery cells to minimize thermal resistance at the time of contact with the battery cells; and
cell covers provided to both ends of the battery module to protect the battery module.

4. The battery device according to claim 2, wherein the housing cover includes a temperature sensor configured to measure an internal temperature of the battery housing.

5. The battery device according to claim 1, wherein the battery housing includes terminals that maintain an airtight seal within an inside of the battery housing.

6. The battery device according to claim 1, wherein the battery housing is mounted with a venting component through which gas is discharged.

7. A battery device, comprising:
a battery module that includes a plurality of plates disposed between a plurality of battery cells and formed of an aluminum material that allows a heat transfer of the battery cells, heat controlling plates disposed between the battery cells to minimize thermal resistance during contact with the battery cells, and cell covers provided to both ends of the plurality of battery cells to protect the battery cells;
a battery housing that forms an opening in a bottom surface thereof to insert the battery module into the opening, fuse a housing cover to the opening with laser to seal a lower portion of the battery housing, and form a plurality of apertures in a top surface thereof having the plurality of plates protrude to the exterior through the plurality of apertures; and
a heat sink disposed on the top surface of the battery housing and having a plurality of discharge grooves formed therein to fixedly insert the plurality of plates into the plurality of discharge grooves, that discharge heat of the plates while sealing an upper portion of the battery housing.

8. The battery device according to claim 7, wherein the battery housing cover includes a temperature sensor configured to measure an internal temperature of the battery housing.
